(19) United States
(12) Patent Application Publication
(10) Pub. No.: US 2025/0145873 A1
(43) Pub. Date: May 8, 2025

(54) BIOBASED, ECO-FRIENDLY HOTMELT ADHESIVE

(71) Applicant: THÜRINGISCHES INSTITUT FÜR TEXTIL- UND KUNSTSTOFF-FORSCHUNG E.V., Rudolstadt (DE)

(72) Inventor: Andreas KRYPCZYK, Rudolstadt (DE)

(73) Assignee: THÜRINGISCHES INSTITUT FÜR TEXTIL- UND KUNSTSTOFF-FORSCHUNG E.V., Rudolstadt (DE)

(21) Appl. No.: 18/931,926

(22) Filed: Oct. 30, 2024

(30) Foreign Application Priority Data
Nov. 7, 2023 (DE) 10 2023 130 729.0

(51) Int. Cl. C09J 167/04; C08K 5/11; C09J 9/00; C09J 167/02

(52) U.S. Cl. CPC C09J 167/04; C08K 5/11; C09J 9/005; C09J 167/02

(57) ABSTRACT

The invention describes an eco-friendly hotmelt adhesive based on renewable raw materials. The hotmelt adhesive formulation is made up of biobased polyesters, specifically a combination of polylactide and polybutylene succinate, and also of resins, plasticizers and stabilizers; further additives may optionally be added as well, for example waxes, fumed silica, lime or color pigments. The raw materials used are sustainable, biodegradable and unhazardous to nature. The adhesive exhibits very good adhesion to wood, paper, cardboard and certain, predominantly non-polar plastics such as PMMA, ABS, PC, PLA or PET and can be applied with the commonplace systems.

### CROSS-REFERENCE TO RELATED APPLICATIONS

This application claims priority to German Patent Application 2023 130 729.0 filed Nov. 7, 2023, which is hereby incorporated herein by reference in its entirety.

### FIELD OF THE INVENTION

The utilization of renewable raw materials as materials is gaining increasingly in importance. Driving forces for this development include climate change and the need to use sources independent of petroleum. The invention describes an eco-friendly hotmelt adhesive based on the biobased polyesters polylactide (PLA) and polybutylene succinate (PBS).

### BACKGROUND OF THE INVENTION

An adhesive tape based on renewable raw materials is known from DE 20 2006 001 693 U1. It comprises a film composed of a blend of polylactic acid (PLA) and at least one aliphatic-aromatic copolyester. Applied to the film is a layer of a pumpable, water-containing adhesive compound. The layer is subsequently dried. Specifically disclosed is a pressure-sensitive adhesive which contains polylactic acid, epoxidized soybean oil, polybutylene succinate and citric acid and which is fluidized prior to application. Hotmelt adhesives, conversely, are solvent-free and water-free adhesives based on thermoplastic polymers. These polymers, solid at room temperature, soften on heating to form viscous fluids and can therefore be applied as a melt. On cooling to room temperature, they undergo reversible solidification at the same time as developing bonding strength. Further constituents of conventional hotmelt adhesives are resins, waxes, plasticizers, stabilizers and fillers. The most commonplace fields of use for conventional hotmelt adhesives are the packaging industry, the hygiene industry, bookbinding, the wood and furniture industries, and the do-it-yourself sector.

The semi-biobased hotmelt adhesives presently available commercially have a high fraction of biobased resins and waxes. The use of biobased resins and waxes has been state of the art for decades. The base polymers used, however, are exclusively petroleum-based.

The company Intercol BV markets a biobased hotmelt adhesive consisting of 70% of natural raw materials.

The company Jowat SE markets, under the trade name JOWATHERM® GROW, a biobased hotmelt adhesive consisting of 50% of natural raw materials.

The company Henkel markets, under the trade name TECHNOMELT® SUPRA ECO, a biobased hotmelt adhesive. In spite of the high fraction of renewable raw materials, the base polymer is synthetically based.

The patent WO2015153226A1 (whose United States equivalent is US 2017/0037218) describes a biobased hotmelt adhesive. The base polymer is PLA. Besides this, no further biobased polymers, and also no biobased rosins or terpene resins, are used as tackifiers or biobased plasticizers.

The patent WO2013162058A1 (whose United States equivalent is U.S. Pat. No. 9,481,815) describes an eco-friendly hotmelt adhesive. Besides biobased raw materials, petrobased raw materials too are described here.

The patent WO2002053376A2 (whose United States equivalent is U.S. Pat. No. 6,838,403) describes a biodegradable and compostable hotmelt adhesive based on PLA. Besides this, no further biobased polymers, and also no biobased rosins or terpene resins, are used as tackifiers.

The patent U.S. Pat. No. 9,428,645B2 describes an eco-friendly hotmelt adhesive based on biobased and petrobased raw materials.

US 2014/0329065 A1 is directed to biodegradable films having a printed layer, a resin layer, an adhesion layer and optionally a carrier layer. The latter consists preferably of paper, a cotton fabric or a fiber web. Polylactide (PLA) is part of the resin layer and/or the adhesion layer. It may be blended with a multiplicity of natural or synthetic polymers, among them polybutylene succinate (PBS). Additionally, there may also be plasticizers present, such as citric acid, citrates, epoxidized vegetable oils, fatty acid esters, polyethylene glycol or glycerol esters. The adhesion layer forms an outer side of the biodegradable film.

Biobased polyesters such as PLA or PBS generally lack sufficient compatibility with the resins used commercially. Furthermore, in comparison to the polymers commonly used, such as ethylene-vinyl acetate (EVA) or polyolefin (PO), the biopolyesters are brittle and of high viscosity, meaning that success has so far eluded the development of a commercially comparable hotmelt adhesive based on biobased polyesters.

PLA and PBS are presently not used for the formulation of hotmelt adhesives and pressure-sensitive hotmelt adhesives. Base polymers used are exclusively ethylene-vinyl acetate (EVA), certain polyolefins and styrene-butadiene (PO) copolymers (SBC). These polymers have been optimized for hotmelt adhesives in recent decades.

PLA and PBS are presently employed predominantly for injection-molded components and for flexible packaging. In contrast to the amount of commercially available types of these polymers, there are only a handful of different types of PBS and a number of types of PLA available. Problematic are the insufficient flexibility, the high melting point and the high melt viscosity by comparison with the customary polymers, all of which have a great importance for hotmelt adhesives. Furthermore, compatibility with the other constituents (resins, waxes) represents a further problem. Compatibility with the polymer must be borne in mind in the same way as the associated effect on the setting characteristic, the flow and solidification characteristics and the interactions of the polymer components at the phase boundary. These factors are a substantial influence on the morphology that arises during production. The number, size and form of the phases present and also their mutual interactions exert authoritative control over the macroscopic properties. Only with good compatibility, in other words without phase separation or demixing of the individual components, is the formulation suitable for use as a hotmelt adhesive.

The biobased polyesters, moreover, are susceptible to hydrolytic chain degradation, which occurs in particular over relatively long periods at relatively high temperatures.

### SUMMARY OF ADVANTAGEOUS EMBODIMENTS OF THE INVENTION

It is an object of the invention to produce a hotmelt adhesive based on PLA and PBS which overcomes the disadvantages described in the prior art, such as low flexibility and the high melting point, yet is to be fully biodegradable.

The object of the invention is achieved by the utilization, as base polymer for the hotmelt adhesive, of a combination of PLA and PBS, processed with correspondingly matched resins, plasticizers and stabilizers to give a fully biobased hotmelt adhesive. An optional possibility is addition of further fillers, such as waxes, fumed silica, lime or color pigments, for example.

### DETAILED DESCRIPTION OF ADVANTAGEOUS EMBODIMENTS OF THE INVENTION

A subject of the invention accordingly is a hotmelt adhesive formulation comprising:
at least one polylactide having a glass transition temperature of more than 50° C., a melt flow index of more than 25 g/10 min, measured at a temperature of 210° C. with a load of 2.16 kg, a weight-average molecular weight M_{w} in the range from 120 000 to 280 000 g/mol and a Hansen solubility parameter of 19.2 to 21.1 (J/cm³)^{0.5}, with the fraction of the at least one polylactide being 5 to 45% by weight, based on the total weight of the hotmelt adhesive formulation;
at least one polybutylene succinate having a melt flow index of 3 to 26 g/10 min, measured at 190° C. with a load of 2.16 kg, a weight-average molecular weight M_{w} in the range from 60 000 to 190 000 g/mol and a Hansen solubility parameter of 20.1 to 21.2 (J/cm³)^{0.5}, with the fraction of the at least one polybutylene succinate being 10 to 55% by weight, based on the total weight of the hotmelt adhesive formulation;
at least one naturally occurring resin having a melting temperature between 6° and 150° C., a melt viscosity of 80 to 24 000 mPa·s at 140° C. and a Hansen solubility parameter between 16.0 and 21 (J/cm³)^{0.5}, with the fraction of the at least one naturally occurring resin being 30 to 55% by weight, based on the weight of the hotmelt adhesive formulation;
at least one citric acid tri (C2-C8)alkyl ester or acetylcitric acid tri (C2-C8)alkyl ester as plasticizer in a fraction of 5 to 15% by weight, based on the total weight of the hotmelt adhesive formulation; and
at least one epoxidized vegetable oil as stabilizer in a fraction of 0.5 to 1.5% by weight, based on the total weight of the hotmelt adhesive formulation.

Unless otherwise indicated, all percent figures in this patent are weight percentages based on the total mass of the respective formulation.

Topmost priority for the formulation of the hotmelt adhesives based on PLA and PBS is the compatibility with respect to the other adhesive components. The compatibility may be determined by way of the Hansen solubility parameter. This is based on the fundamental idea that like dissolves in like, and is expressed in (J/cm³)^{0.5}. Raw materials selected are therefore preferably those having the same or a close solubility parameter. Two components are sufficiently miscible with one another, even at elevated temperature, only if their solubility parameters differ by not more than 1.0 (J/cm³)^{1/2}.

In practice, the compatibility is evaluated visually in the melt and in the solid. In the event of visible phase separation of the materials, the mixture is rated as non-compatible.

The base polymer of a hotmelt adhesive formulation defines the essential properties of the hotmelt adhesive, such as processing temperature, adhesion, chemical and hydrolytic stability, softening range and the mechanism of solidification. A combination of PLA and PBS is used as base polymers for the adhesive formulation of the invention. Through this combination, the properties of the two polymers are combined, thereby overcoming the disadvantages of the individual polymers and emphasizing the positive features. The base polymers are used in a fraction of 40 to 65%.

Polylactide (PLA) is a semicrystalline to fully amorphous, biobased and biodegradable polymer. Commercially available PLA has a glass transition temperature of 53° C. to 64° C., a melting range of 150 to 180° C. and a melt flow rate (MFR) of 6 to 80 g/10 min [210° C./2.16 kg]. The Hansen solubility parameter is 19.2-21.1 (J/cm³)^{0.5}. PLA suitable for the invention has a very high glass transition temperature, preferably >50° C., and a very high MFR, preferably >25 g/10 min [210° C./2.16 kg). For the invention, PLA having an average molecular weight M_{w} in the range from 120 000 to 280 000 g/mol has proven to be particularly suitable.

Polybutylene succinate (PBS) is a crystalline, biobased and biodegradable plastic. PBS has a glass transition temperature of −40° C. to −31° C., a melting range of 85 to 115° C. and an MFR of 3-26 g/10 min [190° C./2.16 kg). The Hansen solubility parameter is 20.9 (J/cm³)^{0.5}. For the invention, PBS having a weight-average molar mass M_{w} in the range from 60 000 to 190 000 g/mol is preferred.

Hotmelt adhesives based on PBS possess high heat stability but poor bonding properties. Hotmelt adhesives based on PLA, conversely, possess good bonding properties, but only low heat distortion temperature. Through the combination in accordance with the invention of these two polymers, hotmelt adhesives can be produced that possess not only high shape stability under heat but also excellent bonding properties.

Having proven to be particularly advantageous is a combination of 50-75% of a low-melting PBS (85° C.) and 25-50% of a high-melting PBS (115° C.). In this case, the high heat stability of the high-melting PBS can be optimally united with the better bonding properties of the low-melting PBS.

For the adhesive formulation, resins adapted specifically for PLA and PBS are used. These biobased resins are added in order to increase the tack, the adhesion and the heat stability and to reduce the processing viscosity. Having proven to be particularly suitable are resins based on rosin and terpenes.

Rosin is a product obtained from tree resin. Owing to its amorphous structure, rosin does not possess a defined melting point and is very brittle. The spectrum ranges from liquid to solid resins having an average melting temperature between 6° and 150° C. and a viscosity of 80 to 24 000 mPa·s at 140° C. The solubility parameter of commercial rosins is situated in general between 17.0 and 19.5 (J/cm³)^{0.5}. For the invention, however, a specific formulation having a solubility parameter of more than 19.0 (J/cm³)^{0.5}, preferably between 19.2 to 21.1 (J/cm³)^{0.5}, is used in order to ensure good compatibility with the biopolyester. Moreover, for the majority of applications, the resin contributes to the flexibilization of the adhesive formulation. Responsibility for this is possessed by the softening point of around 25° C.-35° C., at which the resin has a particularly flexible structure and so optimizes the overall formulation for applications in this temperature range.

Terpenes are hydrocarbon compounds which occur as secondary constituents almost exclusively in plants. The representatives of the terpenes that are most important for resins in hotmelt adhesives are α-pinene, β-pinene and D-limonene. Polyterpenes, or terpene resins, are constructed from a multiplicity of isoprene units (C5H8) n. The terpenes are transformed into resins via thermal oxidation processes. Terpene resins are amorphous with a melting range of 60° C. to 170° C. The solubility parameter of commercial terpene resins is between 16.2 and 20.9 (J/cm³)^{0.5}. Terpene resin preferred for the invention has a Hansen solubility parameter of >20.0 (J/cm³)^{0.5}.

For the invention, resins solid at room temperature, having a melting temperature of less than 120° C. and a melt viscosity of less than 1000 mPa·s at 160° C. are preferred. The resins are preferably designed such that they exhibit a high impact toughness and comparatively high flexibility at room temperature. Moreover, the preferred resins are notable for an excellent hot tack, thus enabling the attainment of high heat stability in spite of the low softening temperature. In the adhesive formulations of the invention, the biobased resins account for 30 to 65% of the total mass, preferably 40 to 55% of the total mass.

For the flexibilization of the biopolyesters, suitable plasticizers are used. They serve to flexibilize the adhesives and lower the processing temperature. The plasticizers may either be compounded with PLA and PBS beforehand or incorporated directly during the production of the hotmelt adhesive.

Biobased plasticizers suitable for the invention are certain citrates. These include triethyl citrate; particularly suitable are relatively long-chain citric esters such as acetyl tributyl citrate and tributyl citrate, as they are more temperature-stable and have a lower propensity to migrate. The plasticizers are preferably compounded with the PLA beforehand. A proportion of 10-25% plasticizer, based on the fraction of PLA in the adhesive formulation, d as being particularly efficient. Through the addition of plasticizers it is possible to reduce the elasticity modulus, the tensile strength and the Shore hardness, so that the modified PLA achieves the mechanical properties of commercial EVA. The tensile elongation in particular is greatly increased. This leads to sufficient flexibilization of the otherwise very hard hotmelt adhesives with polylactide as a constituent.

An addition of plasticizers to PBS leads to a deterioration in the adhesive and cohesive properties without generating significant flexibilization. Surprisingly, however, it emerged that the combination of a PLA/plasticizer blend and PBS does not lead to a deterioration in the properties; instead, the positive properties of the plasticized PLA are retained and additionally are improved further by the properties of the PBS. The formulations are therefore strongly flexibilized, with an associated increase in the impact toughness and simultaneous reduction in the viscosity, thus actually enabling the processing of the adhesives in the planned areas of application.

For stabilization against hydrolytic decomposition, epoxidized vegetable oils are used. Particularly suitable are epoxidized linseed oil or epoxidized soybean oil, which are added in a fraction of less than 1.5% and serve both as plasticizers and stabilizers or for protection from hydrolysis. Used as preferably for the invention are epoxidized vegetable oils having an epoxy oxygen content of 8.5-9.5%, an acid number of 0.1-1.0 [mg KOH/g] and a viscosity of around 500 to 1500 mPa·s at 25° C. In the industrial operation, hotmelt adhesives are often exposed to relatively high temperatures for a relatively long time. In the processing of the hotmelt adhesives, a stable viscosity is a significant property. Through the addition of stabilizers, the viscosity reduction under a temperature load of 160° C. over 24 h can be lowered by up to 50%.

To formulate a hotmelt adhesive from PLA and PBS, it is necessary for plasticizer, resin and stabilizer all to be compatible with one another, so that there is no phase separation. In addition, the bonding properties and the heat distortion temperature must be not reduced as a result of the adjuvants but instead, ideally, improved further.

A hotmelt adhesive formulation of the invention consists of 5 to 45% PLA, 10 to 55% PBS, 30 to 55% resin, up to 15% plasticizer and 0.5 to 1.5% stabilizer.

Hotmelt adhesives are typically produced in a stirred reactor in a batch process. Extrusion here takes place only in exceptional cases. In the stirred reactor, however, relatively high residence times are needed, signifying a relatively long temperature load on the raw materials used. The biopolymers used are substantially more susceptible to thermal decomposition processes under prolonged temperature load, meaning that an extrusion process is appropriate when formulating the hotmelt bioadhesives. Such a process allows firstly the residence time to be considerably reduced and secondly lower temperatures to be used. With hotmelt adhesives, underwater pelletization poses an additional challenge. Their stickiness gives rise to problems in the production of uniformly shaped pellets at room temperature (RT). In the process, therefore, the water bath is additionally cooled via an external heat exchanger to 5 to 10° C. In the production of the adhesive formulations, the PLA and the PBS are metered in as pellets in the intake zone at 20-30° C. The resins are fed in in melted form at around 140-170° C. in the compression zone. Via further liquid metering, a mixture of the plasticizer and the stabilizer is introduced in the compression zone. Alternatively, the PLA may be compounded beforehand and pelletized with the plasticizer in a first step at 140° C.-160° C.

A formulation of the invention contains 5 to 45% PLA, 10 to 55% PBS, 30 to 55% resin, 0.5 to 1.5% epoxidized vegetable oil and 5 up to 15% plasticizer. Additives may optionally be added for cost reduction and/or coloring. These additives may account for up to 20% by weight, based on the overall formulation. The additives are fillers, lime, color pigments or fumed silica, for example. The additives are preferably particles having an equivalent spherical diameter of not more than 150 μm, more preferably of 0.1 to 100 μm, more particularly of 1 to 25 μm.

For further improvement in the properties of the hotmelt adhesive, biobased waxes may optionally be incorporated. They serve primarily to lower viscosity and to reduce the open times and setting times. Carnauba, candelilla and stearin waxes have proved to be particularly suitable.

Carnauba wax is a wax which is obtained from the leaves of the carnauba palm. Carnauba wax possesses a light yellowish to greenish color and is the hardest natural wax. Its melting point is high for waxes, at 80° C. to 87° C.

Candelilla wax is a wax which is obtained from the leaves and stems of the candelilla shrub. It is hard, frangible, yellowish brown and opaque to translucent, with a melting point of 67 to 79° C.

Stearin is a mixture of stearic and palmitic acids, which is obtained from the corresponding triglycerides by saponification and acidification of the soapy liquor. The melting range of stearin is dependent on composition and lies between 55 and 70° C.

For the invention, preference is given to waxes which are solid at room temperature, having a softening temperature of less than 90° C. and a melt viscosity of less than 1000 mPa·s at 100° C. Preferred waxes having these properties are carnauba, candelilla or stearin waxes. In the adhesive formulations of the invention, the biobased waxes account for preferably 0 to 20% of the total mass.

The hotmelt adhesives are used as pellets or blocks or as glue sticks. For rapid operations as in the packaging or hygiene industry, hotmelt adhesives with a low-viscosity and rapid setting characteristics are particularly preferred. Suitable accordingly are formulas having a relatively low fraction of PLA and PBS (<50%) and a relatively high fraction of resin and plasticizer (>50%). A particular part here is also played by the tailing. The latter is to be as low as possible, in order to promote precise application and to minimize contamination of the systems. Very low tailing can be achieved through the combination of PLA and PBS in a ratio of 2:8 to 8:2.

The bonding properties and the thermal stability play a secondary part in these applications, as the products produced therewith are usually short-lived. Here, formulations having a relatively high plasticizer content (>10%) and a relatively high PLA content (>40%) are preferred. A high fraction of PLA in comparison to PBS ensures shorter setting times, and a low viscosity can be achieved as a result of the high plasticizer content.

For the bookbinding sector or for edge gluing in the wood and furniture industries, the thermal stability and strength play a significant part. A low viscosity is not mandatory. For this application, therefore, only a low part of plasticizer (<5%) and a high fraction of polymer (>55%) and resin (>40%) are used. In the DIY sector as well, for glue sticks, for example, the viscosity plays a minor part. Important here are a low melting point and good bonding properties, in order to ensure good handling.

The examples hereinafter serve to illustrate the invention.

### Raw Materials Used

(A1) Base polymer: polylactide, CAS number: 26100-51-6, INGEO® 4060D from Natureworks LLC, melting point: 160° C., MFR (210° C./2.16 kg)
(A2) Base polymer: polybutylene succinate, CAS number: 25777-14-4, BIO-PBS™ FZ91PM from Mitsubishi Chemical, melting point: 115° C., MFR (190° C./2.16 kg)
(A3) Base polymer: polybutylene succinate, CAS number: 25777-14-4, BIO-PBS™ FD92PM from Mitsubishi Chemical, melting point: 84° C., MFR (190° C./2.16 kg)
(A4) Base polymer: polyhydroxyalkanoate, PHACT® a1000p from Helian Polymers BV; melt flow index (MFI) at 160° C. and 5 kg loading: 5 g/10 min; amorphous poly[(R)-3-hydroxybutyrate-co-4-hydroxybutyrate (P3HB4HB)
(B1) Tackifier: rosin, BREMAR® pp 1181 from Robert Kraemer, softening range: 60° C. to 80° C.
(B2) Tackifier: rosin, BREMAR® pp 1017 from Robert Kraemer, softening range: 80° C. to 100° C.
(B3) Tackifier: terpene resin, DERTOPHENE® H150, from DRT, softening range: 80° C. to 120° C.
(B4) Tackifier: terpene resin, SYLVARES® TP 300, from Kraton, 100° C. to 130° C.
(B5) Tackifier: terpene resin, SYLVARES® TP 2040, from Kraton, 110° C. to 140° C.
(B6) Tackifier: rosin, BREMAR® RK 8133 from Robert Kraemer; liquid at room temperature, viscosity: about 9000 mPa·s at 60° C.
(B7) Tackifier: rosin, ROKRAPOL® RK 6898 from Robert Kraemer; solid at room temperature, melting point: 80° C., viscosity (160° C.): less than 500 mPa·s
(C1) Plasticizer: acetyl tributyl citrate, CAS number: 77-90-7
(C2) Plasticizer: tributyl citrate, CAS number: 77-94-1
(D1) Wax: carnauba wax, CAS number: 8015-86-9, CARNAUBAWACHS™ LT 124, from TH. C. TROMM, solidification point: 80° C. to 87° C.
(D2) Wax: candelilla wax, CAS number: 8006-44-8, CANDELILLAWACHS™ LT 281 BI from TH. C. TROMM, solidification point: 65° C. to 73° C.
(D3) Wax: stearin wax, CAS number: 22610-63-5, TECE-STEARIN® I from TH. C. TROMM, solidification point: 55° C. to 59° C.
(E1) Stabilizer: epoxidized linseed oil, MERGINAT® ELO from Hobum Oleochemicals, CAS number: 8016-11-3, viscosity: 700 mPa·s to 1300 mPa·s at 25° C.
(E2) Stabilizer: epoxidized soybean oil, MERGINAT® ESBO from Hobum Oleochemicals, CAS number: 8013-07-8, viscosity: 400 mPa·s to 600 mPa·s at 20° C.

### Methods

(M1) Determination of the lap shear strength [MPa] according to DIN EN 1465: two steel sheets are bonded with an overlap area of 12.5×25 mm and pulled apart with a tensile testing machine. The lap shear strength determined describes the bonding force (adhesion, cohesion) of the adhesive.
(M2) Shear Adhesion Failure Temperature (S.A.F.T.) [° C.] based on ASTM D4498: two steel sheets are bonded with an overlap area of 25×25 mm. The bonded sheets are hung up and loaded with a 200 g weight. They are then heated by 2° C./min in a drying cabinet. The temperature at which the bond parts is termed the S.A.F.T. It provides information about the heat stability of the adhesive.
(M3) Melting point [° C.] according to DIN EN ISO 11357: the melting point is determined via DSC (differential scanning calorimetry). The measuring range is −50° C. to 200° C. The heating rate is 20 K/min. (M4) Viscosity measurement [mPa·s] at 160° C. according to DIN EN ISO 3219: the viscosity is determined via a plate/plate rheometer. It provides information about the deformation and flow characteristics of the adhesive at certain temperatures. In the course of the measurement, the sample is sheared between the rotating or oscillating part and the stationary part of the arrangement. The shear rate is a product of the geometry of the measuring arrangement and the velocity of the moving part. The torque required in order to maintain the movement is measured, and can then be used for determination of the shear stress and hence the viscosity and other rheological parameters.
(M5) Open time [s]: the open time is defined by the time which elapses until the adhesive is no longer tacky. At regular intervals of time, a wooden pick is pressed onto a bead of adhesive (application at 160° C.) and pulled off. As soon as the pick sticks (cohesive fracture), the hotmelt adhesive is rated as “open”. When the pick no longer sticks on the bead of hotmelt adhesive, the hotmelt adhesive is no longer open.
(M6) Setting time [s]: the setting time describes the time which elapses until the adhesive has developed a notable cohesion. A dot of adhesive is applied to the end of a wooden pick. An identical pick is pressed on immediately at a 90° angle, producing an overlap and bond area. At the same time, a measurement of the time is commenced. At regular intervals, attempts are made manually to twist the picks (not too strongly) and a determination is made of the moment at which the picks can no longer be moved.

### Example 1

For a typical hotmelt adhesive, the PLA was dried beforehand at 45° C. and the two PBS types at 60° C. for 4 h. The compounding took place in a twin-screw extruder from Leistritz, model ZSE™ 27 MAXX, having a screw length of 1.12 m and a screw diameter of 28 mm at 125-160° C., with a total throughput of 8-10 kg/h, a screw speed of 80-150 rpm and a setpoint pressure of 5 bar.

The two types of PBS were premixed in a pellet mixer, and then the PLA and the two PBS types were metered in in the intake zone at 20-30° C. via respective single-screw feeders, model DS28™ from Brabender. The resin was supplied at 150° C. via a heated liquid feeder in the compression zone. The plasticizer was metered at room temperature (RT) via a liquid feeder, model FDDW-M-P™ from Brabender, in the compression zone. The melt was discharged via an underwater pelletizer at an exit temperature of 120-130° C. with a cutting-blade speed of 500-1500 rpm and a water temperature of 5-20° C. The formulas R1 to R4, plus R13 and R14, were produced in this way. Owing to the high bonding force and high thermal stability, the formulas are particularly suitable for the textile, footwear and automotive industries.

### Example 2

The formulations were produced very largely in analogy to Example 1. To achieve a relatively low melting point, the relatively high-melting PBS FZ91™ was omitted. There was therefore no need for premixing as in Example 1. In formulations R7 and R8, moreover, a terpene resin was used so as to improve the adhesion on defined substrates. This resin was supplied at 170° C. via a heated liquid feeder in the compression zone. The formulas R5 to R8 were produced in this way. Owing to the relatively low melting point, the formulas are particularly suitable for glue sticks.

### Example 3

The formulations were produced very largely in analogy to Example 1. To achieve a relatively high heat stability, the low-melting PBS FD92™ was omitted. There was therefore no need for premixing as in Example 1.

The rosin in R9 was supplied at 150° C. and the terpene resins in R9-R11 at 170° C. via a heated liquid feeder in the compression zone. The formulas R9 to R12 were produced in this way. Owing to the high heat stability and viscosity, the formulas are particularly suitable for edge gluing in the wood and furniture sector.

### Example 4

The formulations were produced very largely in analogy to Example 1. Additionally, various waxes were metered in via a twin-screw feeder, model DDSR20™ from Brabender, at 20° C.-30° C. in the intake zone. The resin was supplied at 150° C. via a heated liquid feeder in the compression zone. The formulas R15 to R20 were produced in this way. The use of waxes reduces the viscosity and also the processing times for the adhesive systems. These formulas are therefore particularly suitable for rapid operations of the kind customary in the packaging sector.

### Formulas

### Produced as in Example 1—Use in Footwear, Textile and Automotive Industries

| | | R1 | R2 | R3 | R4 | R105 | R106 | R107 | R108 |
|---|---|---|---|---|---|---|---|---|---|
| INGEO ® 4060 D | A1 | 7.5 | 7.5 | 15.0 | 44.0 | 25.0 | 25.0 | 15.0 | 45.0 |
| BIO-PBS ™ FZ91 | A2 | 13.0 | 10.0 | 10.0 | 2.5 | 20.0 | 20.0 | 44.0 | 10.0 |
| BIO-PBS ™ FD92 | A3 | 41.0 | 30.0 | 30.0 | 7.5 | | | | |
| PHACT ® a1000p | A4 | | | | | 15.0 | 15.0 | | |
| BREMAR ® PP1181 | B1 | 35.0 | 49.0 | 39.0 | 30.0 | 39.0 | | | |
| BREMAR ® PP1017 | B2 | | | | | | | | |
| DERTOPHENE ® | B3 | | | | | | | | |
| H150 | | | | | | | | | |
| SYLVARES ® | B4 | | | | | | | | |
| TP 300 | | | | | | | | | |
| SYLVARES ® | B5 | | | | | | | | |
| TP 2040 | | | | | | | | | |
| BREMAR ® RK | B6 | | | | | | 29.0 | 20.0 | 44.0 |
| 8133 | | | | | | | | | |
| ROKRAPOL ® | B7 | | | | | | 10.0 | 20.0 | |
| RK 6898 | | | | | | | | | |
| Acetyl tributyl | C1 | 2.5 | 2.5 | 5.0 | 15.0 | | | | |
| citrate | | | | | | | | | |
| Tributyl citrate | C2 | | | | | | | | |
| Carnauba | D1 | | | | | | | | |
| wax LT 124 | | | | | | | | | |
| Candelilla | D2 | | | | | | | | |
| wax LT 281 BI | | | | | | | | | |
| Stearin | D3 | | | | | | | | |
| wax TECE- | | | | | | | | | |
| STEARIN ® I | | | | | | | | | |
| Epoxidized | E1 | 0.5 | 0.5 | 0.5 | 0.5 | 0.5 | 0.5 | 0.5 | 0.5 |
| linseed oil | | | | | | | | | |
| Epoxidized | E2 | 0.5 | 0.5 | 0.5 | 0.5 | 0.5 | 0.5 | 0.5 | 0.5 |
| soybean oil | | | | | | | | | |
| Sum total | | 100.0 | 100.0 | 100.0 | 100.0 | 100.0 | 100.0 | 100.0 | 100.0 |
| Lap shear | M1 | 3.1 | 3.3 | 3.0 | 2.3 | 3.2 | 3.5 | 3.3 | 2.7 |
| strength [MPa] | | | | | | | | | |
| S.A.F.T. | M2 | 132.5 | 125.5 | 130.0 | 79.2 | 131.2 | 127.8 | 133.4 | 121.4 |
| Melting | M3 | 115.5 | 114.9 | 114.2 | 109.5 | 115.4 | 114.8 | 115.4 | 115.7 |
| point [° C.] | | | | | | | | | |
| Viscosity/160° | M4 | 46100 | 5900 | 28700 | 28900 | 43000 | 47700 | 25400 | 17500 |
| C. [mPa · s] | | | | | | | | | |
| Open time/160° | M5 | 110 | 140 | 120 | 130 | 90 | 90 | 100 | 110 |
| C. [s] | | | | | | | | | |
| Setting time/ | M6 | 50 | 90 | 50 | 70 | 40 | 40 | 45 | 55 |
| 160° C. [s] | | | | | | | | | |

### Produced as in Example 2—Lower Melting Temperature, Used for Example in Glue Sticks

| | | R5 | R6 | R7 | R8 | R109 | R110 | R111 | R112 |
|---|---|---|---|---|---|---|---|---|---|
| INGEO ® 4060 D | A1 | 24.0 | 7.5 | 35.0 | 7.5 | 10.0 | 15.0 | 25.0 | 20.0 |
| BIO-PBS ™ FZ91 | A2 | | | | | | | | |
| BIO-PBS ™ FD92 | A3 | 25.0 | 49.0 | 10.0 | 35.0 | 25.0 | 35.0 | 30.0 | 20.0 |
| PHACT ® a1000p | A4 | | | | | 20.0 | 10.0 | | 15.0 |
| BREMAR ® | B1 | 44.0 | 40.0 | | | 44.0 | 40.0 | | |
| PP1181 | | | | | | | | | |
| BREMAR ® | B2 | | | | | | | | |
| PP1017 | | | | | | | | | |
| DERTOPHENE ® | B3 | | | 44.0 | 54.0 | | | | |
| H150 | | | | | | | | | |
| SYLVARES ® | B4 | | | | | | | | |
| TP 300 | | | | | | | | | |
| SYLVARES ® | B5 | | | | | | | | |
| TP 2040 | | | | | | | | | |
| BREMAR ® RK | B6 | | | | | | | 34.0 | 29.0 |
| 8133 | | | | | | | | | |
| ROKRAPOL ® | B7 | | | | | | | 10.0 | 1.0 |
| RK 6898 | | | | | | | | | |
| Acetyl tributyl | C1 | 6.0 | 2.5 | 10.0 | 2.5 | | | | |
| citrate | | | | | | | | | |
| Tributyl citrate | C2 | | | | | | | | |
| Carnauba | D1 | | | | | | | | |
| wax LT 124 | | | | | | | | | |
| Candelilla | D2 | | | | | | | | |
| wax LT 281 BI | | | | | | | | | |
| Stearin | D3 | | | | | | | | |
| wax TECE- | | | | | | | | | |
| STEARIN ® I | | | | | | | | | |
| Epoxidized | E1 | 0.5 | 0.5 | 0.5 | 0.5 | 0.5 | 0.5 | 0.5 | 0.5 |
| linseed oil | | | | | | | | | |
| Epoxidized | E2 | 0.5 | 0.5 | 0.5 | 0.5 | 0.5 | 0.5 | 0.5 | 0.5 |
| soybean oil | | | | | | | | | |
| Sum total | | 100.0 | 100.0 | 100.0 | 100.0 | 100.0 | 101.0 | 100.0 | 100.0 |
| Lap shear | M1 | 2.6 | 3.2 | 2.5 | 3.2 | 3.8 | 3.5 | 2.8 | 3.3 |
| strength [MPa] | | | | | | | | | |
| S.A.F.T. | M2 | 81.9 | 83.6 | 84.4 | 79.0 | 82.7 | 84.8 | 84.1 | 86.4 |
| [° C.] | | | | | | | | | |
| Melting | M3 | 84.1 | 87.1 | 83.2 | 85.0 | 84.4 | 87.4 | 85.4 | 84.5 |
| point [° C.] | | | | | | | | | |
| Viscosity/160° | M4 | 8200 | 41600 | 37800 | 43200 | 34400 | 37500 | 35400 | 48400 |
| C. [mPas] | | | | | | | | | |
| Open time/160° | M5 | 150 | 130 | 120 | 140 | 150 | 130 | 120 | 120 |
| C. [s] | | | | | | | | | |
| Setting time/ | M6 | 100 | 60 | 70 | 80 | 100 | 80 | 70 | 65 |
| 160° C. [s] | | | | | | | | | |

### Produced as in Example 3—Used in Edge Gluing: Furniture Industry, Wood and Furniture Industry

| | | R9 | R10 | R11 | R12 | R115 | R116 | R117 | R118 | R13 | R14 |
|---|---|---|---|---|---|---|---|---|---|---|---|
| INGEO ® 4060 | A1 | 20.0 | 15.0 | 19.0 | 23.0 | 25.0 | 20.0 | 25.0 | 25.0 | 15.0 | 34.0 |
| D | | | | | | | | | | | |
| BIO-PBS ™ | A2 | 35.0 | 40.0 | 44.0 | 39.0 | 25.0 | 34.0 | 29.0 | 29.0 | 10.0 | 2.5 |
| FZ91 | | | | | | | | | | | |
| BIO-PBS ™ | A3 | | | | | | | | | 30.0 | 12.5 |
| FD92 | | | | | | | | | | | |
| PHACT ® | A4 | | | | | 20.0 | 15.0 | 15.0 | 10.0 | | |
| a1000p | | | | | | | | | | | |
| BREMAR ® | B1 | 39.0 | | | | 34.0 | 30.0 | | | 29.0 | 20.0 |
| PP1181 | | | | | | | | | | | |
| BREMAR ® | B2 | | 39.0 | | | | | | | 10.0 | 20.0 |
| PP1017 | | | | | | | | | | | |
| DERTOPHENE ® | B3 | | | | | | | | | | |
| H150 | | | | | | | | | | | |
| SYLVARES ® | B4 | | | 30.0 | | | | | | | |
| TP 300 | | | | | | | | | | | |
| SYLVARES ® | B5 | | | | 30.0 | | | | | | |
| TP 2040 | | | | | | | | | | | |
| BREMAR ® RK | B6 | | | | | | | 20.0 | 25.0 | | |
| 8133 | | | | | | | | | | | |
| ROKRAPOL ® | B7 | | | | | | | 10.0 | 10.0 | | |
| RK 6898 | | | | | | | | | | | |
| Acetyl | C1 | 5.0 | 5.0 | 6.0 | 7.0 | | | | | | |
| tributyl | | | | | | | | | | | |
| citrate | | | | | | | | | | | |
| Tributyl | C2 | | | | | | | | | 5.0 | 10.0 |
| citrate | | | | | | | | | | | |
| Carnauba | D1 | | | | | | | | | | |
| wax LT 124 | | | | | | | | | | | |
| Candelilla | D2 | | | | | | | | | | |
| wax LT 281 BI | | | | | | | | | | | |
| Stearin wax | D3 | | | | | | | | | | |
| TECE- | | | | | | | | | | | |
| STEARIN ® I | | | | | | | | | | | |
| Epoxidized | E1 | 0.5 | 0.5 | 0.5 | 0.5 | 0.5 | 0.5 | 0.5 | 0.5 | 0.5 | 0.5 |
| linseed oil | | | | | | | | | | | |
| Epoxidized | E2 | 0.5 | 0.5 | 0.5 | 0.5 | 0.5 | 0.5 | 0.5 | 0.5 | 0.5 | 0.5 |
| soybean oil | | | | | | | | | | | |
| Sum total | | 100.0 | 100.0 | 100.0 | 100.0 | 105.0 | 100.0 | 100.0 | 100.0 | 100.0 | 100.0 |
| Lap shear | M1 | 2.9 | 2.7 | 2.5 | 2.4 | 2.9 | 2.6 | 2.4 | 3.1 | 3.1 | 2.7 |
| strength [MPa] | | | | | | | | | | | |
| S.A.F.T. | M2 | 127.1 | 135.8 | 137.2 | 130.3 | 134.4 | 132.1 | 134.1 | 129.4 | 122.7 | 98.3 |
| [° C.] | | | | | | | | | | | |
| Melting | M3 | 114.8 | 116.2 | 116.7 | 115.8 | 114.4 | 115.3 | 116.1 | 114.9 | 113.9 | 110.1 |
| point [° C.] | | | | | | | | | | | |
| Viscosity/160° | M4 | 31000 | 45300 | 72300 | 58600 | 54000 | 72600 | 66700 | 64400 | 35100 | 45500 |
| C. [mPa · s] | | | | | | | | | | | |
| Open time/ | M5 | 120 | 110 | 90 | 100 | 90 | 70 | 80 | 100 | 130 | 140 |
| 160° C. [s] | | | | | | | | | | | |
| Setting time/ | M6 | 70 | 60 | 50 | 55 | 50 | 40 | 45 | 55 | 60 | 80 |
| 160° C. [s] | | | | | | | | | | | |

### Produced as in Example 5—Relatively Low Lap Shear Strength, Relatively Low Viscosity, Low Processing Temperature, Application: Packaging Industry

| | | R15 | R16 | R17 | R18 | R19 | R20 | R121 | R122 | R123 | R124 |
|---|---|---|---|---|---|---|---|---|---|---|---|
| INGEO ® 4060 D | A1 | 34.0 | 39.0 | 41.5 | 39.0 | | | 30.0 | 30.0 | | |
| BIO-PBS ™ FZ91 | A2 | | | | | 10.0 | 20.0 | | | 10.0 | 10.0 |
| BIO-PBS ™ FD92 | A3 | | | | | 40.0 | 30.0 | | | 25.0 | 20.0 |
| PHACT ® a1000p | A4 | | | | | | | 15.0 | 10.0 | 34.0 | |
| BREMAR ® | B1 | 50.0 | 30.0 | 45.0 | 40.0 | 39.0 | 29.0 | 34.0 | | 10.0 | 10.0 |
| PP1181 | | | | | | | | | | | |
| BREMAR ® | B2 | | | | | | | | | | |
| PP1017 | | | | | | | | | | | |
| DERTOPHENE ® | B3 | | | | | | | | | | |
| H150 | | | | | | | | | | | |
| SYLVARES ® | B4 | | | | | | | | | | |
| TP 300 | | | | | | | | | | | |
| SYLVARES ® | B5 | | | | | | | | | | |
| TP 2040 | | | | | | | | | | | |
| BREMAR ® RK | B6 | | | | | | | | 29.0 | | 24.0 |
| 8133 | | | | | | | | | | | |
| ROKRAPOL ® | B7 | | | | | | | | 15.0 | | 20.0 |
| RK 6898 | | | | | | | | | | | |
| Acetyl tributyl | C1 | | | | | | | | | | |
| citrate | | | | | | | | | | | |
| Tributyl citrate | C2 | 10.0 | 15.0 | 7.5 | 10.0 | | | 20.0 | 15.0 | | |
| Carnauba | D1 | 5.0 | 15.0 | | | | | | | | |
| wax LT 124 | | | | | | | | | | | |
| Candelilla | D2 | | | 5.0 | 10.0 | | | | | | |
| wax LT 281 BI | | | | | | | | | | | |
| Stearin | D3 | | | | | 10.0 | 20.0 | | | 20.0 | 15.0 |
| wax TECE- | | | | | | | | | | | |
| STEARIN ® I | | | | | | | | | | | |
| Epoxidized | E1 | 0.5 | 0.5 | 0.5 | 0.5 | 0.5 | 0.5 | 0.5 | 0.5 | 0.5 | 0.5 |
| linseed oil | | | | | | | | | | | |
| Epoxidized | E2 | 0.5 | 0.5 | 0.5 | 0.5 | 0.5 | 0.5 | 0.5 | 0.5 | 0.5 | 0.5 |
| soybean oil | | | | | | | | | | | |
| Sum total | | 100.0 | 100.0 | 100.0 | 100.0 | 100.0 | 100.0 | 100.0 | 100.0 | 100.0 | 100.0 |
| Lap shear | M1 | 2.4 | 1.9 | 2.2 | 2.0 | 2.5 | 2.7 | 2.1 | 2.3 | 2.5 | 2.6 |
| strength [MPa] | | | | | | | | | | | |
| S.A.F.T. [° C.] | M2 | 63.1 | 58.9 | 67.4 | 60.8 | 124.9 | 122.1 | 71.4 | 66.6 | 124.1 | 122.2 |
| Melting | M3 | — | — | — | — | 115.7 | 114.3 | — | — | 115.0 | 115.7 |
| point [° C.] | | | | | | | | | | | |
| Viscosity/160° | M4 | 6600 | 3500 | 7100 | 5200 | 8700 | 2400 | 4100 | 5600 | 2100 | 3500 |
| C. [mPa · s] | | | | | | | | | | | |
| Open time/160° | M5 | 70 | 50 | 100 | 80 | 60 | 40 | 60 | 80 | 55 | 60 |
| C. [s] | | | | | | | | | | | |
| Setting time/ | M6 | 40 | 20 | 55 | 45 | 25 | 15 | 35 | 50 | 30 | 30 |
| 160° C. [s] | | | | | | | | | | | |

A1: PLA of type INGEO® 4060D
A2: BIO-PBS™ of type FZ91PM
A3: BIO-PBS™ of type FZ92PM
A4: Amorphous poly[(R)-3-hydroxybutyrate-co-4-hydroxybutyrate] (PHACT®)
B1: Rosin of type BREMAR® pp 1181
B2: Rosin of type BREMAR® pp 1017
B3: Terpene resin of type DERTOPHENE® H150
B4: Terpene resin of type SYLVARES® TP 300
B5: Terpene resin of type SYLVARES® TP 2040
B6: Rosin of type BREMAR® RK 8133
B7: Rosin of type ROKRAPOL® RK 6898
C1: Acetyl tributyl citrate (ATBC)
C2: Tributyl citrate
D1: Wax of carnauba wax type CARNAUBAWACHS™ LT 124
D2: Wax of candelilla wax type CANDELILLAWACHS™ LT 281 BI
D3: Wax of stearin wax type STEARINWACHS TECE-STEARIN® I
E1: Epoxidized linseed oil of type MERGINAT® ELO
E2: Epoxidized soybean oil of type MERGINAT® ESBO
M1: Lap shear strength [MPa]
M2: Heat stability [° C.]
M3: Melting point [° C.]
M4: Viscosity [mPa·s]
M5: Open time [s]
M6: Setting time [s]

### Comparative Examples

In accordance with the details for the layer identified as “Resin layer” in the examples of US 2014/0329065 A1, formulas as follows were investigated:

| Component | Designation | C1 | | C2 | |
|---|---|---|---|---|---|
| Polylactide | INGEO ® 4060D | 100 | g | 100 | g |
| (PLA) | | | | | |
| Polybutylene | PBS FZ91 | — | | 30 | g |
| succinate | | | | | |
| (PBS) | | | | | |
| Plasticizer | ATBC | 50 | g | 50 | g |
| Acrylate | Acrylate- | 10 | g | 10 | g |
| copolymer | styrene | | | | |
| | copolymer | | | | |
| Stearin | TECE-STEARIN ® | 8 | g | 8 | g |
| | I | | | | |
| Crosslinker | Citric acid | 5 | g | 5 | g |
| Calcium | Calcium | 50 | g | 50 | g |
| carbonate | carbonate | | | | |
| Sum total | | 223 | g | 253 | g |

All the components, except for the calcium carbonate, were mixed for around 120 min at 180° C. in an anchor stirrer. Following addition of calcium carbonate, the formulation exhibited a very high viscosity. The stearin wax was not compatible with polylactide, resulting in separation.

Because of the poor homogeneity and compatibility of the components, it was not possible to conduct any investigations for the purpose of characterizing the mixtures. In the absence of a tackifier, the adhesion properties were inadequate.

That which is claimed:

1. A hotmelt adhesive formulation comprising:
at least one polylactide having a glass transition temperature of more than 50° C., a melt flow index of more than 25 g/10 min, measured at a temperature of 210° C. with a load of 2.16 kg, a weight-average molecular weight M_{w} in the range from 120 000 to 280 000 g/mol and a Hansen solubility parameter of 19.2 to 21.1 (J/cm³)^{0.5}, with the fraction of the at least one polylactide being 5 to 45% by weight, based on the total weight of the hotmelt adhesive formulation;
at least one polybutylene succinate having a melt flow index of 3 to 26 g/10 min, measured at 190° C. with a load of 2.16 kg, a weight-average molecular weight M_{w} in the range from 60 000 to 190 000 g/mol and a Hansen solubility parameter of 20.1 to 21.2 (J/cm³)^{0.5}, with the fraction of the at least one polybutylene succinate being 10 to 55% by weight, based on the total weight of the hotmelt adhesive formulation;
at least one naturally occurring resin having a melting temperature between 6° and 150° C., a melt viscosity of 80 to 24 000 mPa·s at 140° C. and a Hansen solubility parameter between 16.0 and 21 (J/cm³)^{0.5}, with the fraction of the at least one naturally occurring resin being 30 to 55% by weight, based on the weight of the hotmelt adhesive formulation;
at least one citric acid tri (C2-C8)alkyl ester or acetylcitric acid tri (C2-C8)alkyl ester as plasticizer in a fraction of 5 to 15% by weight, based on the total weight of the hotmelt adhesive formulation; and
at least one epoxidized vegetable oil as stabilizer in a fraction of 0.5 to 1.5% by weight, based on the total weight of the hotmelt adhesive formulation.

2. The hotmelt adhesive formulation as claimed in claim 1, which contains up to 20% by weight, based on the total weight of the hotmelt adhesive formulation, of additive(s),

3. The hotmelt adhesive formulation as claimed in claim 2, wherein the additive(s) are fillers selected from lime, color pigments or fumed silica

4. The hotmelt adhesive formulation as claimed in claim 2, wherein the additives are particles having an equivalent spherical diameter of not more than 150 μm.

5. The hotmelt adhesive formulation as claimed in claim 2, wherein the additives are particles having an equivalent spherical diameter of 0.1 to 100 μm,

6. The hotmelt adhesive formulation as claimed in claim 2, wherein the additives are particles having an equivalent spherical diameter of 1 to 25 μm.

7. The hotmelt adhesive formulation as claimed in claim 2, wherein the additive is a biobased wax having a softening temperature of less than 90° C. and a melt viscosity of less than 1000 mPa·s at 100° C., preferably a carnauba, candelilla or stearin wax.

8. The hotmelt adhesive formulation as claimed in claim 7, wherein the biobased wax is a carnauba, candelilla or stearin wax.

9. The hotmelt adhesive formulation as claimed in claim 1, wherein the epoxidized vegetable oil is an epoxidized linseed oil or an epoxidized soybean oil, in each case having an epoxy oxygen content of 8.5 to 9.5% by weight, an acid number of 0.1 to 1.0 [mg KOH/g] and a viscosity of 500 to 1500 mPa·s at 25° C.

10. The hotmelt adhesive formulation as claimed in claim 1, wherein the citric ester is triethyl citrate, tributyl citrate or acetyl tributyl citrate.

11. The hotmelt adhesive formulation as claimed in claim 1, which comprises a combination of 50 to 75% by weight of a polybutylene succinate having a melting point or melting range of 60 to 90° C. and 50 to 25% by weight of a polybutylene succinate having a melting point or melting range of 110 to 125° C.

12. The hotmelt adhesive formulation as claimed in claim 1, wherein the naturally occurring resin is a resin based on rosin or on terpenes whose Hansen solubility parameter is in each case more than 20 (J/cm³)^{0.5}.

13. The hotmelt adhesive formulation as claimed in claim 1, wherein the Hansen solubility parameters of the components stated in claim 1 differ from one another by not more than 1.0 (J/cm³)^{0.5}.

14. The hotmelt adhesive formulation as claimed in claim 13, wherein the Hansen solubility parameters of the components stated in claim 1 differ from one another by not more than 0.5 (J/cm³)^{0.5}.

15. A bookbinding glue, furniture glue, paper adhesive, cardboard adhesive or non-polar plastic adhesive comprising a hotmelt adhesive formulation as claimed in claim 1.

16. A bookbinding glue, furniture glue, paper adhesive, cardboard adhesive or non-polar plastic adhesive as claimed in claim 15, wherein the non-polar plastics are poly(methyl methacrylate) (PMMA), acrylonitrile butadiene styrene (ABS), polycarbonate (PC) or polyethylene terephthalate (PET).
